(19) United States
(12) Patent Application Publication
(10) Pub. No.: US 2006/0240473 A1
(43) Pub. Date: Oct. 26, 2006

(54) Saccharide libraries

(75) Inventors: Andrew Powell, Hants (GB); Jeremy Turnbull, Shropshire (GB); Edwin Yates, West Midlands (GB)

Correspondence Address: ELMORE PATENT LAW GROUP, PC, 209 MAIN STREET, N. CHELMSFORD, MA, 01863, US

(73) Assignee: The University of Liverpool, Liverpool, GBN (GB)

(21) Appl. No.: 10/521,522

(22) PCT Filed: Jul. 17, 2003
(86) PCT No.: PCT/GB03/03236

§ 371 Date: Aug. 15, 2005

(30) Foreign Application Priority Data
Jul. 19, 2002 (GB) 0216861.5

(51) Int. Cl. C40B 40/04; C08B 37/10; C40B 40/12

(52) U.S. Cl. 435/7.1; 536/21

(57) ABSTRACT

Novel methodologies for producing saccharide libraries are provided as well as the libraries themselves.

The invention relates to the production and functionalisation of heparan sulfate sequences and related sequences. The invention finds application in the production of heparan sulfate and related sequences, diverse and focused libraries of such sequences and the determination of functions associated with the sequences.

Heparan sulfate (HS) proteoglycans are cell-surface molecules widely found on mammalian cells and consist of a core protein and complex, sulfated linear glycosaminoglycan (carbohydrate) chains. These sugar chains belong to the wider glycosaminoglycan (GAG) family, which also contains chondroitin sulfate, dermatan sulfate and keratan sulfate. HS chains bind to a variety of molecules including growth factors, enzymes, adhesion molecules and receptors and it is these interactions that are thought to underlie the large number of biological activities attributed to HS. Heparan sulfate consists of linear polysaccharide chains composed of repeating glucosamine-glucuronate and glucosamine-iduronate disaccharides. These saccharides can be modified by attachment of certain chemical groups at various, but restricted, positions to the saccharide rings. Glucosamine (sometimes designated A-standing for aminosugar) can possess an N-sulfate or N-acetyl group attached to the nitrogen atom (N-) and O-sulfates at position 6 or, more rarely, 3 (6-O, 3-O sulfates). Iduronate (sometimes designated I) can frequently, and glucuronate (sometimes designated G) more rarely, possess sulfate at position 2 (2-O sulfate). A combination of these structures within the naturally occurring heparan sulfate allows the creation of chains containing diverse, unique sequences of saccharides.

Heparan sulfate is structurally the most complex of the GAGs, both in terms of the variety of its constituent monosaccharides and the complexity of their arrangement along the sugar chain (i.e the sequence). Particular HS saccharide sequences (displaying particular patterns of sulfation) bind to specific proteins and these HS-protein interactions underlie a huge variety of cellular functions (including development, differentiation, growth and repair mechanisms) and also many disease processes (eg. heart and blood vessel disorders, cancer, asthma, arthritis, Alzheimers). Many reports in the literature also suggest that interactions between HS on the surface of mammalian host cells and a wide range of pathogens and parasites are important for infection. The interactions between individual HS sequences and proteins or cells are therefore major new therapeutic targets. The identification of bioactive HS sequences and the characterisation of the mechanism of their action will permit compounds which mimic or block sugar functions to be discovered, potentially leading to a new class of drugs targetting a range of diseases. Indeed, the identified sequences themselves have potential as novel drugs.

One major practical problem in this area of research is the scarcity of HS available from natural sources. A commonly used approach is to employ the widely available, structurally related, but generally more heavily sulfated molecule heparin, which is itself a very widely-used antithrombotic agent. Heparin, which shares the same underlying structural framework as HS, is considered by some to be a form of HS and exhibits a range of compositions dependent on its origin. However, it possesses higher overall levels of sulfation and, generally, contains a lower proportion of glucuronic acid and N-acetyl glucosamine residues. While these properties have sometimes lead heparin to be considered as a more homogeneous compound than HS, it is nevertheless, still considered a relatively complex molecule.

Previous work in this area has attempted to simplify this relative structural complexity of heparin because it was considered a complicating factor. Indeed, HS, heparin and oligosaccharides derived from them have frequently been considered as intractable for structural studies precisely because of their sequence complexity. This is particularly so when mixtures of saccharides are produced because they can contain large numbers of structures, often similar or related, that are difficult to separate. In response to this complexity, attempts have been made to instigate simple global changes, for example, by removing all of one particular type of sulfate group and observing how this change influences the activity of the sample. The intended result of such work is to make the correlation of biological activity and structure more straightforward. The individual chemical processes have comprised:

Selective de-sulfation of N-sulfated glucosamine

De O-sulfation in iduronate and glucosamine residues

Selective de-O-sulfation of iduronate residues

Selective de O-sulfation in glucosamine residues

N-sulfation of unsubstituted amino groups in glucosamine

N-acetylation of unsubstituted amino groups in glucosamine

There are many examples of this type of approach in the scientific literature and a typical example of the overall philosophy is outlined in Kariya et al J. Biol. Chem. (2000) 275 25949-25958 who stated: “Specific removal of major sulfate groups of heparin such as 2-O-sulfate, 6-O-sulfate, and N-sulfate groups would be useful in order to clarify the backbone structures of oligosaccharides bearing specific arrays of sulfate groups responsible for the interactions with physiologically active molecules. For instance, selective removal of 6-O-sulfate groups from glucosamine residues of heparin is of great importance in order to evaluate the involvement of 6-O-sulfate group(s) in the interaction between heparin, bFGF, and FGF receptors (FGFRs).”

This prior art approach has been broadened to include work in which the chemical steps have been carried out to completion in several positions. The object in these cases has still been to make products that are structurally simpler than the starting material, again, with the aim of correlating biological activity and structure. The Inventors have published similar work in which combinations of complete (and one partial) modifications and their structural characterisation by ¹H and ¹³C NMR were described and a more recent publication in which single complete, as well as the combination of a complete and a partial chemical modification to heparin, have been correlated with biological activity. However, such an approach can be criticised on the grounds that it is not necessarily the case that chemical groups can be removed piecemeal without affecting the structure of the molecule in some other way.

By taking an alternative approach, the Inventors have devised the methods described herein, which can deliberately create libraries of compounds derived from heparin/HS that increase still further the structural diversity within the HS sample and, indeed, have the potential to create maximum structural (and hence sequence) diversity possible within the limits imposed by the nature of the material (i.e. heparin/HS) and the chemistry of the individual steps, whilst including substitutions only at those positions of the constituent monosaccharides that are found substituted in the naturally occurring products. In distinction to the prior art, in which efforts concentrated on finding biologically relevant structures within heparin or HS, the Inventors are interested in finding optimised active structures from the vastly increased pool of structures available by this approach, irrespective of the representation of such structures within the naturally occurring products.

In addition, the processes described herein are distinct from many examples in the prior art, in which HS (and GAGs in general) have been modified in ways additional to removal of sulfate groups from positions found sulfated or acetylated in the naturally occurring material. For example, those methods in which sulfates are introduced at position 3 of iduronate or O-acetyl groups are introduced. In the current invention, no sulfate or acetyl group is added to positions within the constituent monosaccharides that is not found to bear this group in the monosaccharide units contained within the naturally occurring material.

Several examples of apparent chemical modification to heparin, HS or related GAGs can be found in the patent literature, for example, U.S. Pat. No. 5,430,133, U.S. Pat. No. 5,405,949, U.S. Pat. No. 5,543,403, U.S. Pat. No. 5,958,899, U.S. Pat. No. 4,717,719 and EP0380719. In particular, selective de-O-sulfation at iduronate-2-sulfate groups employing highly basic conditions. This modification is intended to result in selective removal of 2-O-sulfate groups from iduronate; in fact, it also results in the introduction of unnatural modifications (in the small amounts of N,3 disulfated and N,3,6 trisulfated glucosamine residues present in heparin, see Yates et al., Carbohydr. Res., (1997) 298 335-340) while its incomplete application introduces epoxide groups in the iduronate residues (see M. Jaseja et al., Can. J. Chem., (1989) 67 1449-1456). The present invention does not rely on the introduction of any such abberant substitutions.

Furthermore, the compound libraries produced by the methods of the present invention have the capacity to be “tuned”, i.e. the methods can be used to find an active compound or one minimising, for example, size and charge, and then regenerate a sub-library of related, but subtly different structures, some of which may exhibit improved activity. This allows a chosen property of these molecules to be optimised, for example size, charge or activity, and further compounds to be produced in which the chosen property is enhanced.

Thus in a first aspect, the invention provides a method for the production of a library of heparan sulfate derivatives produced by a combination of chemical modifications selected from the group A to O:
A. partial de N-sulfation in glucosamine
B. complete de N-sulfation in glucosamine
C. partial de N-acetylation in glucosamine
D. complete de N-acetylation in glucosamine
E. re N-sulfation in glucosamine of all available amino groups
F. re N-acetylation in glucosamine of all available amino groups
G. partial re N-sulfation in glucosamine
H. partial re N-acetylation in glucosamine
I. complete de-O-sulfation at position 6 of glucosamine
J. partial de-O-sulfation at position 6 of glucosamine
K. partial de-O-sulfation at both position 6 of glucosamine and 2 of iduronate accompanied by complete de N-sulfation in glucosamine.
L. complete de-O-sulfation at both position 6 of glucosamine, 2 of iduronate and de-N-sulfation in glucosamine
M. partial de-O-sulfation at position 6 and complete de-N-sulfation of glucosamine
N. complete de-O-sulfation at position 2 of iduronate
O. complete de-O-sulfation at position 6 and de N-sulfation of glucosamine and partial de-O-sulfation of iduronate

Partial means not all of the available groups are modified, complete means all of the available groups are modified.

Whilst it will be understood that two or more compounds can constitute a library, the methods of the invention allow libraries to be made in which structural diversity is increased compared to the starting material (HS/heparin), or used to their ultimate extension, structural diversity is maximised, i.e. combinations of modifications are chosen such that the library contains HS molecules with very highly diverse chemical structures. Libraries produced by the methods of the invention also permit re-preparation of the components or for their production to be optimised, that is, to be tuned towards compound(s) with desired structures and/or functions (or new, but structurally related ones to be made). Such compounds may possess minimum size or charge but retain a certain level of activity, for instance. The methods of the invention allow the deliberate increase of structural diversity (i.e heterogeneity) in compound libraries. One method of ascertaining the overall level of structural diversity present in such samples is to conduct enzymatic (e.g heparatinase I, II and III) and/or chemical degradation and observe the pattern formed by the products on a separative technique, for instance gel electropherogram or HPLC trace.

The term “heparan sulfate” is defined herein to include heparan sulfate, heparin, heparan sulfate-like GAGs or other heparin-like GAGs either in the form of polysaccharides, often considered to be longer than 20 monosaccharide units, or in the form of oligosaccharides, generally considered in the art to comprise fewer than 20 monosaccharide units although the boundary between the two is essentially arbitrary. Some authorities consider heparin to be a subclass of heparan sulfate, others that it is distinct. In any case, both are members of the wider glycosaminoglycan family. Herein, “heparan sulfate” also means any derivative of the above list formed by combinations of modifications found in the prior art. Thus the methods of the invention may be used to further modify heparan sulfate derivatives made by methods other than those described herein. “heparan sulfate derivatives” means compounds produced from the methods of the invention, including the modifications of heparin or heparan sulfate described herein and any further method steps, for example digestion of a modified polysaccharide, to produce a pool of oligosaccharides, or other chemical modifications. “Heparin or heparan sulfate” used herein includes glycosaminoglycan molecules derived from natural sources, or those arising from chemical modification of these compounds, or fragments, multivalent complexes or aggregations derived from these.

Various combinations and orders of modification reactions are logically possible in the methods of the invention. By “any combination” it is meant all combinations or orders of modification steps except where the combinations or orders are not considered logically possible by a person skilled in the art. By naming the position and type of sugar in which a modification is made, (for example, position 6 of glucosamine, or position 2 of iduronate—also called glucosamine-6-O-sulfate or iduronate-2-O-sulfate respectively), it is meant that these changes occur throughout the sample and to the extent indicated (partial or complete) and, in the case where a single species has not been isolated, it means that this property is that observed when averaged over the whole sample. This will include a distribution of molecules with modifications of different extent within the sample.

It will be clear to a person skilled in the art that various combinations of the modification steps are possible, including for example:—

(i) Incomplete de N-sulfation in glucosamine; this can be achieved alone or at the same time as de-O-sulfation (either partial or complete at position 6 of glucosamine or 2 of iduronate).

(ii) Complete de N-sulfation; this can be achieved alone under mild conditions, as in (i) above, but also occurs under harsher conditions such as those used to achieve 6 de-O-sulfation in glucosamine, 2-de-O-sulfation in iduronate and, under yet harsher conditions, complete de-O-sulfation throughout.

(iii) It is also possible to remove 2-O-sulfates in iduronate residues selectively only if all of these are removed. This reaction takes place via a different reaction to those above, but if it were carried out to only partial extent, it would result in the formation of unwanted epoxide groups in some of the former iduronate-2-sulfate groups.

(iv) 6-O-desulfation of glucosamine can be achieved by reacting the pyridinium salt of heparin in pyridine with a silylating agent, MTSTFA (N-methyl-N-(trimethylsilyl)trifluoroacetamide), to form silylated derivatives. These can then be selectively cleaved under aqueous conditions to give a derivative containing 6 de-O-sulfated glucosamine residues either to partial or complete extent.

(v) De-N-acetylation in glucosamine by certain methods e.g. NaOH and heat results in the formation of epoxides and probably also de-sulfation in previously 2-O-sulfated iduronate residues. A similar method of carrying out de N-acetylation in glucsoamine involves treatment with hydrazine.

(vi) Selective re-N-sulfation and re-N-acetylation in glucosamine, either partial or complete, are easily achieved as described herein.

The predominant repeating disaccharide structure of heparin and heparan sulfate can be shown as: 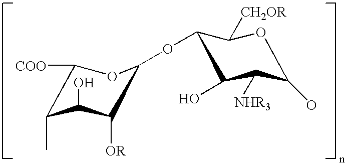
4) L-iduronic acid alpha(1-4) D-glucosamine alpha (1
   where R₁=H, or O-sulfate (SO₃⁻), R₂=H, or O-sulfate and R₃=H, or N-sulfate (SO₃⁻). Beta D-glucuronic acid and its 2-O-sulfated derivative can replace iduronate. Glucosamine can be N-acetylated. In addition, there is a small amount of glucosamine bearing 2,3 and 2,3,6 di and trisulfate groups.

The general structure of heparan sulfate (and heparin) is based on a repeating disaccharide composed of alpha (1-4) linked uronic acid (either alpha-L-iduronic acid or beta D-glucuronic acid) 1-4 linked to alpha-D-glucosamine to form a linear polysaccharide, which is then decorated with a combination of O- and N-sulfates and/or N-acetyl and free-amines. In the case of O-sulfates, these may occur at position-2 of the iduronate residue (and also more rarely at position-2 of glucuronate) and position-6 of glucosamine (and occasionally at position-3 of glucosamine). At the amino function of glucosamine, N-sulfate, N-acetyl and (it has been suggested) free amines can exist. Considering only the predominant repeating disaccharide of heparin; -4) alpha-L-iduronate (1-4) alpha-D-glucosamine (1-, There are twelve possible theoretical combinations of substitutions (2 at iduronate-2: hydroxyl or O-sulfate, 2 at glucosamine-6; hydroxyl or O-sulfate and 3 at glucosamine-N; free amine, N-sulfate or N-acetyl, giving 2×2×3=12 combinations).

For a tetrasaccharide there are, therefore, 144 possible combinations (calculated from 12^{N/2}, where N=the degree of polymerisation, here N=4) and for a hexasaccharide. (N=6), there are 1728 combinations etc (i.e. these molecules contain a much higher degree of potential diversity than, say, peptides). Most of these sequences have not been found naturally occurring, but are nonetheless theoretical possibilities if the chemistry can be exploited. So, the relative complexity of naturally occurring HS is but a fraction of that possible if all sequence combinations are considered. Added to this level of sequence complexity is the variable chain length both within the naturally occurring polysaccharides, their chemically modifed derivatives and the products formed from them by degradative techniques.

“Complete modification” as defined herein refers to modifications carried out on all of those positions available for that modification; “partial modification” as defined herein refers to modifications being carried out to fewer than the total available positions, i.e. incomplete modification. These definitions must be understood within the limit of detection of the technique used (i.e. of the actual experiment, not the theoretical limit of the modification). For example, 90, 80, 70, 60% of the modification reaction HS substrate (by which is meant the percentage of particular residues within the chains, not the percentage of the chains) has been converted to product. The gross structural change might be measured, for example, by ¹³C NMR and, practically, this is able to distinguish between, for instance 90, 80, 70, 60% levels of substitution but not between say, 99 and 99.9%.

Chemical modifications which result in accidental remnants, may be taken into account and considered as complete modifications provided that a significant proportion of the product is present in the library or in the next step of modification. So, a complete modification (for example N-sulfation) can be defined as either converting all amino groups to N-sulfates or all available free-amino groups (i.e. those not N-acetylated) to N-sulfates. Partial modifications (e.g. N-sulfation) is defined as meaning converting some, but not all amino groups, or available amino groups to N-sulfate, for example only 10, 20, 30, 40, 50, 60% of groups are converted in the product. However, while remnants of unmodified groups may remain, it would be expected that, if carried out as part of the common practice of attempting to simplify correlations between the structure and function, such products would, in cases where unacceptable levels remained, be re-submitted to a repeat of the reaction in order to increase the levels of the desired modification. Under such circumstances, it would be counter-intuitive for a person skilled in the art to submit a compound known to contain significant levels of unmodified groups to subsequent steps, particularly if this was another partial modification or other partial modifications.

If a single sample of the starting material is taken and is subjected progressively to a chemical modification, the sample will first contain an increasingly varied range of sequences within the saccharide chains. If the treatment is continued, a maximum level of structural heterogeneity will be reached but, as more and more of the individual disaccharide units within the chains find themselves adjacent to disaccharides of identical structure, the sample will become progressively homogeneous. This describes the situation within a single sample along a simple reaction trajectory. A library of such compounds could contain not only many compounds, for example, taken at various points along this single reaction trajectory but, also many more taken along a large number of different, single and multiple reaction trajectories. The result is that libraries according to the invention can potentially possess huge diversity. For example, in a library of HS saccharides of twenty monosaccharides, there are theoretically, 12^{20/2}=12¹⁰ (in excess of ten thousand million) possible sequences. While it might be theoretically possible to access all of these, practically it is unlikely and, in any case, it would be impossible at the present time to assess this number of structures. An important point, however, is that such a library still allows a vast number of potentially active sequences to be uncovered that, hitherto, have been neither found nor made.

In a preferred embodiment of the invention, a “library” of compounds comprises at least 50 compounds

The degree of structural complexity within such a sample can be qualitatively assessed by monitoring its breakdown products by some separative technique, (e.g. hplc or gel electrophoresis) following, for example, heparitinase enzyme digestion or nitrous acid degradation. The level of diversity within the library will depend on the number of points at which samples have been taken during chemical modification and on the particular combinations and extents to which those modifications have been taken.

Thus the invention provides methods for the creation of a library of modified heparan sulfate derivatives wherein said library is structurally more diverse than the heparan starting material from which it is derived.

Further examples of possible modifications are as follows;

(i) Selective de N-sulfation; either partial or complete and, by using harsher conditions but the same reactants, complete de N-sulfation can be accompanied by partial de-O-sulfation (either partially or completely) at position 2 of iduronate and position 6 of glucosamine.

(ii) Selective de-O-sulfation of iduronate 2-O-sulfate; this is achieved by a different reaction than that mentioned above and can only be carried out to completion. Partial reaction invariably results in the presence of unnatural epoxide groups forming in the iduronate residue.

(iii) Selective de-O-sulfation at position 6 of glucosamine; this can be carried out to completion, in which case it is accompanied by some de-O-sulfation in iduronate and complete de-N-sulfation in glucosamine. Alternatively, a reaction with a higher degree of selectivity for de-O-sulfation of 6-O- over 2-O-positions than in reaction (ii) above and reportedly resulting in few, if any, other modifications occurring in the structure is available. This can be carried out either partially or completely.

(iv) Re N-sulfation; this can be achieved with complete selectivity, either partially or to completion.

(v) Re N-acetylation; this is possible either partially or to completion.

In the following, it should be understood that certain modifications e.g. partial de-O-sulfation of glucosamine can therefore be achieved by different routes, either carrying out one modification at a time, or concertedly.

Thus one embodiment of the first aspect of the invention provides methods for the production of a library of modified heparan sulfate derivatives wherein said method comprises a combination of chemical modification steps in which at least one, two or three modification steps of said combination are selected from the group A to O.

In a further embodiment, the invention provides methods for the production of a library of modified heparan sulfate derivatives wherein all steps of said combination are chosen from the group A to O.

In a further embodiment, the invention provides methods for the generation of a library of modified heparan sulfate derivatives wherein at least one modification step in said combination is a partial modification.

In another embodiment, the invention provides methods for the creation of a library of modified heparan sulfate derivatives wherein at least one modification is carried out at the amino function (N—) of glucosamine. In a preferred embodiment, at least one partial modification is carried out at the amino function (N—) of glucosamine.

Another embodiment provides methods for the generation of a library of modified heparan sulfate derivatives wherein at least two modification steps in said combination are partial modifications.

An additional embodiment provides methods for the creation of a library of modified heparan sulfate derivatives wherein at least three modification steps in said combination are partial modifications.

A further embodiment provides methods for the generation of a library of modified heparan sulfate derivatives wherein a first step of modification is chosen from A, B, C or D, such that wherein step A is chosen, optional subsequent steps are one or more of E, F, G, H, I, J, K, L, M, N, O or wherein step B is chosen, optional simultaneous or subsequent steps are one or more of E, F, G, H, I, J, K, L, M, N, O in any combination;

An additional embodiment provides methods for the generation of a library of modified heparan sulfate derivatives wherein a second step of modification chosen from E, F, G, or H is performed upon the modified products of said first step.

A further embodiment provides methods for the creation of a library of modified heparan sulfate derivatives wherein a third step of modification chosen from A, B, C, D, E, F, G, H, I, J, K, L, M, N, O is performed upon the modified products of said second step.

Another embodiment provides methods for the creation of a library of modified heparan sulfate derivatives wherein a fourth step of modification chosen from A, B, C, D, E, F, G, H, I, J, K, L, M, N, O is performed upon the modified products of said third step.

An additional embodiment of the invention provides methods for the creation of a library of modified heparan sulfate derivatives wherein the combination of modifications is chosen from a first step and second to fourth optional steps such that:

| | Optional | Optional | Optional |
|---|---|---|---|
| First Step | Second Step | Third Step | Fourth Step |
| B(+/−any of I to O) | G | F/H | |
| B(+/−any of I to O) | H | E/G | |
| B(+/−any of I to O) | E | | |
| B(+/−any of I to O) | F | | |
| A | F | +/−any of I to O | E/G |
| A | H | +/−any of I to O | E/G |

In a preferred embodiment, the invention provides methods for the creation of a library of modified heparan sulfate derivatives wherein said first step modification is B (+/− any of I to O), said second step modification is H, and said third step modification is E or G.

Another preferred embodiment of the invention provides methods for the creation of a library of modified heparan sulfate derivatives wherein said first step modification is B (+/− any of I to O), said second step modification is G, and said third step modification is F or H.

In another embodiment, the invention provides a method for the creation of a library containing at least two modified HS derivatives.

Heparin/HS polysaccharides can be cleaved into oligosaccharides of differing sizes using endoglycosidases and/or by nitrous acid or free radical degradation (e.g. using hydrogen peroxide) which cleave at different positions along the chain. Heparin/HS poly- and oligosaccharides can be separated according to size and charge using chromatography.

Thus in another embodiment of the invention, methods are provided wherein chemical or enzymatic degradation products of such components are created.

In another embodiment of the invention, methods are provided wherein a series of chemical modification steps is carried out by taking aliquots from a reaction vessel, or where the steps are carried out to different extents in discrete locations.

The methods of the invention not only enable the production of diverse libraries of HS derivatives, but also permit such libraries to be “tuned” or optimised for a desired structural or functional feature found amongst the members of the library. In other words, once a member of a library produced by the methods of the invention has been identified as having a desired overall structure and/or particular structural feature (e.g. degree of sulfation, sequence, content of a particular monosaccharide residue etc) and/or a desired function, for example, it tests positive in an assay for inducing cell motility, then further libraries can be produced by adjusting the modifications to give a new library. This may be of closely related derivatives, i.e. focussing in on producing more derivatives that are structurally and/or functionally similar to the active derivative.

Thus in a second aspect, the invention provides a method which comprises the additional steps (singly or jointly) of;

(a)(i) determining at least one functional property of one or more compounds;

(b)(i) making a further library via the method according to any one of the above methods wherein said modifications are chosen according to the functional determination or determinations made in step (a)(i); and/or;

(a)(ii) determining at least one structural feature of one or more compounds;

(b)(ii) making a further library via the method according to any one of the above methods, wherein said modifications are chosen according to the structural determination or determinations made in step (a)(ii); and/or,

(b)(iii) making a further library via the method according to any one the above methods, wherein said modifications are chosen according to both said functional determination(s) made in step (a)(i) and said structural determination(s) made in step (a)(ii).

As defined herein, determining a structural feature means ascertaining any physical property that can be influenced or controlled by the processes described in the first aspect of the invention. Such properties are primarily position and extent of modification, for example; iduronate-2 sulfate, glucosamine-6-O-sulfate and either N-sulfate, N-acetyl or free-amine in glucosamine residues and also the dimensions of the saccharides. Another structural feature could be the charge properties of the saccharides. The dimensions of the saccharides could be determined by gel-based techniques, comparing to standards and/or mass spectrometry. The position and extent of modification can be determined in a gross fashion; averaging over the whole sample by, for example, NMR; in more detail, for example, by disaccharide compositional analysis or, in yet more detail; by carrying out sequencing, employing for example, gel-based techniques and/or mass spectrometry.

As defined herein, determining a functional property means screening one or more components of a library produced by the above methods for a particular desired biological function, for example, binding to a specific biological entity or exhibiting a biological activity such as the ability to stimulate cell-proliferation, differentiation or motility.

Thus, libraries according to the invention can give structural or functional cues which may be used to create further “tuned” libraries. Two basic ways of “tuning” libraries of the invention are envisaged. The first, which can be termed “analytical” facilitates the production, in higher abundance of a component or components, (or closely related variants, some of which, it is hoped, possess improved activity), with a given structure, or structural feature, from a library, once something is known about the structure. The second, which can be called “empirical”, can increase the abundance of a compound with desired characteristics, and possibly, find closely related variants with improved activity, without necessarily knowing anything about the structure of the product.

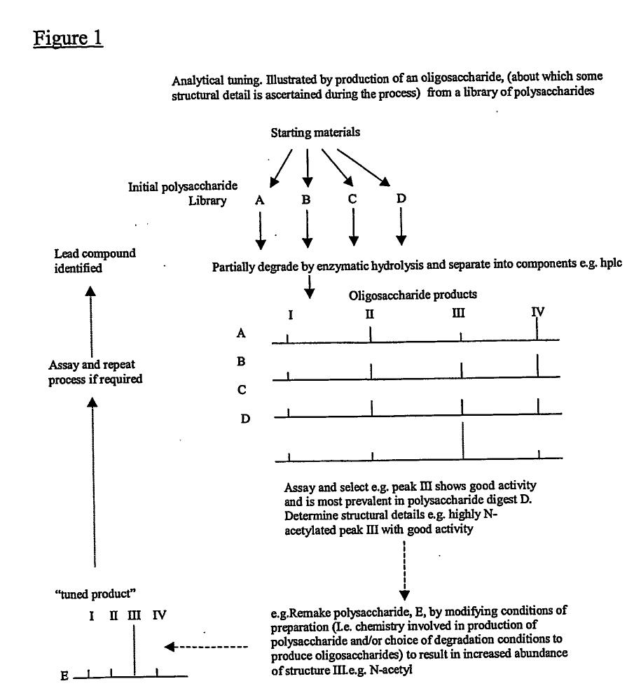

For example, in the “analytical” method of tuning (see FIG. 1), having made a series of products, for example, several oligosaccharide pools from several partially digested polysaccharides and having separated them, for example, by hplc, into their components (or mixtures of a few, structurally related oligosaccharides), the one or ones showing a particular property (for example an activity of interest) is/are selected and analysed for structural composition (for example, by NMR, mass spec, disaccharide composition or sequencing) and the information so obtained (for example, size, charge, degree of sulfation or acetylation at various positions) is used to adjust the subsequent preparation of the products of a further library or libraries (polysaccharide and/or mixture of oligosaccharides) to give the particular structure in greater abundance i.e. to increase the likelihood of it being made, or to create related compounds, which may possess higher activity. This process can usefully be repeated several times. In “analytical tuning” at the level of polysaccharides, a set of structurally diverse, chemically modified polysaccharides is made, constituting a library. This is tested for some activity and the activity correlates with a particular structural feature e.g. high levels of N-acetylation. Polysaccharides are then made based around increased levels of N-acetylation and these products re-tested and some found which, in this hypothetical case, possess higher activities.

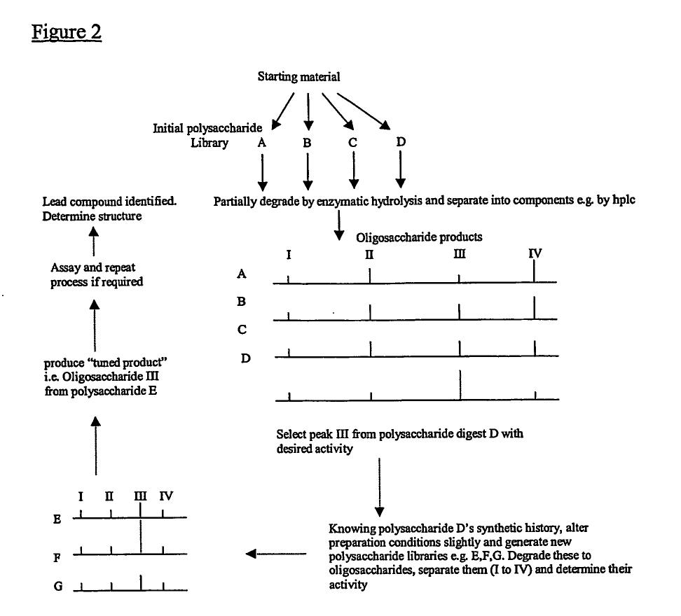

An “empirical” (see FIG. 2) method of tuning involves testing the same set of products (for example, oligosaccharides) for activity and, having located the one(s) of interest, slightly varying the conditions of production (which are known) around those used to produce that particular set of products. (Note that some indication of physical property e.g. degree of overall sulfation may however become apparent for instance from the compound's elution position on an hplc trace). This will give a second set of products, which are themselves then screened for activity (this process could be repeated several times). The preparation of the particular product is thereby optimised without necessarily having any knowledge of what it is; that could be addressed at a later stage.

In a further example of “empirical tuning” at the polysaccharide level, a set of compounds may be tested for a particular activity without knowledge of the structural features of the components of the polysaccharides, but with a knowledge of the steps taken during their preparation, and a particular polysaccharide component may be selected for a particular activity. Polysaccharides are then prepared based around these conditions and tested for activity and some found to possess improved activity.

In both of these definitions the words “increase abundance” include the meaning “increase abundance in an absolute or in a relative way”; this covers the possibility that it may, under certain circumstances, be advantageous to increase the abundance of one component over another, which is not necessarily the same as optimising for the production of one particular component per se. (A more detailed description of the tuning process and pictorial representations are given in the Examples below with reference to FIGS. 1 and 2).

The invention also provides a method of producing a supplementary library of heparan sulfate derivatives comprising steps (singly or jointly) of;

(i) screening (i.e. testing) a library of heparan sulfate derivatives for compounds which have particular structural and/or functional characteristics,

(ii) determining at least one structural feature of the compounds having said particular structural and/or functional characteristics, or

(iii) determining at least one functional property of the compounds having said particular structural and/or functional characteristics, or

(iv) determining at least one functional and one structural property of the compounds having said particular structural and/or functional characteristics; steps (ii), (iii) and (iv) being followed by step

(v) making said further library via the methods of any one of the above methods wherein the modifications and number of modification steps are chosen according to the determinations of steps (ii), (iii) or (iv).

In another embodiment, the invention provides a method wherein at step (v) above, a single combination of modification steps is chosen in order to reproduce only the compound(s) having said desired characteristics.

Other types of tuning, for example, optimising the ratio of two activities, or the ratio between an activity and some structural property are variants of the above and are hence considered within the scope of the invention.

In an additional embodiment, the invention provides a method wherein two activities, or the ratio between some structural property or two structural properties (e.g. size and charge) of components of the library are optimised by either of the above mentioned analytical or empirical tuning methods.

In another embodiment, the invention provides a method wherein the library of heparan sulfate or heparan sulfate derivatives is made by a method according to any of the above claims.

(iv) determining at least one functional and one structural property of the compounds having said particular structural and/or functional characteristics; steps (ii), (iii) and (iv) being followed by step

(v) making said further library via the methods of any one of the above methods wherein the modifications and number of modification steps are chosen according to the determination of steps (ii), (iii) or (iv).

In another embodiment, the invention provides a method wherein at step (v) above a single combination of modification steps is chosen in order to reproduce only the compound or compounds having said desired characteristics.

Other types of tuning, for example, optimising the ratio of two activities, or the ratio between an activity and some structural property, or two structural properties (e.g. size and charge) are variants of the above and are hence considered within the scope of the invention.

In an additional embodiment, the invention provides a method wherein two activities, or the ratio between some structural property or properties of components of the library are optimised by either of the above mentioned analytical or empirical tuning methods.

In another embodiment, the invention provides a method wherein the library of heparan sulfate or heparan sulfate derivatives is made by a method of the first aspect of the invention.

In an additional embodiment, the invention provides a method wherein the structural determination(s) made at step (ii) or (iv) above is/are provided by the discreet known location, in a spatially separated library, of the compounds having said particular structural and/or functional characteristics.

Once a compound having a desired structure or function has been found within a library made by the methods of the invention, additional quantities can then be re-made either following a structural analysis, or from a knowledge of its reaction history, for example from records of the modifications carried out or, preferably, by virtue of the fact that compounds can be spatially located in accordance with the reactions to which they have been subjected. In either case, re-synthesis can be carried out without necessarily knowing any structural information.

Thus in a further embodiment, methods are provided wherein components of the library of heparan sulfate derivatives are spatially located to allow one or more of them to be remade by virtue of the fact that the spatial location corresponds to the process which has been applied to produce that component or components.
There are a wide range of screening methods and approaches known in the art which can be employed to detect or measure a functional property of a component or components of the libraries (for example, Guimond, S. E. and Turnbull, J. E. (1999) Curr Biol. 9, 1343-1346. Irie, A., Yates, E. A., Turnbull, J. E. and Holt, C. E. (2002). Development. 129, 61-70. Kreuger, J., Salmivirta, M., Sturiale, L., Gimenez-Gallego, G. and Lindahl, U. (2001) J Biol Chem. 276, 30744-52. Nadkarni, V. D. and Linhardt, R. J. (1997) Biotechniques. 23, 382-5. Nadkarni, V. D., Pervin, A. and Linhardt, R. J. (1994) Anal Biochem. 222, 59-67).

These include; spatially separated components of the library being tested in any in vitro or in vivo assay, or firstly being bound, either covalently or non covalently, to a surface. An assay may determine an ability to bind, an affinity or activity of a component of the library for, or against, for example, a protein, another carbohydrate, cells, viruses or other biological or chemical entity.

In other words, the screening of components, or spatially separated components of the library, can be performed:
in crystals as complexes with proteins or peptides
in free solution in vitro experiments as well as in vivo; or
immobilised on one or more of the following;
   a matrix
   a resin
   on beads (including magnetic)
   on derivatised surfaces

Attachment to this variety of surfaces and supports may occur via covalent binding or non-covalent attachment and may be in the form of slides, wells, plates, beads, compact discs etc. Surfaces can be, for example, polypropylene, polystyrene, gold, silica, ceramics or metal, nitrocellulose, PVDF, nylon or phosphocellulose. All of these can be employed to bring a component of the library into the proximity of a test compound, in order for some functional property of the library component to be determined. Having identified components of the library with the desired function, their production can be repeated and the components further separated for re-screening using the assay. The location of components can correlate with the history of treatments employed to create that particular component.

In a further embodiment of the first and second aspects of the invention provides a library in the form of modified heparan sulfate derivatives in which the compounds contained therein are spatially separated at discreet known locations. This facilitates rapid screening and tuning.

In another embodiment, the invention provides an array comprising a surface upon which are deposited each at spatially defined locations, a component, or components of a library of heparan sulfate derivatives made by the methods of the invention.

In a further embodiment the invention provides an array comprising a surface upon which are deposited each at spatially defined locations at least two heparan sulfate derivatives, (poly- or oligosaccharides) derived from said derivatives, produced by the methods of the invention described herein.

Thus in the method of the second aspect of the invention the functional determination(s) made at step a(i) and/or structural determination(s) made at step a(ii) is/are provided by the discreet known location, in a spatially separated library, of the compounds having said particular structural and/or functional characteristics.

Each position in the pattern of an array according to the invention can contain, for example, either:
a sample of heparan sulfate derivative(s) or
a sample of heparan sulfate derivative(s) bound to an interacting molecule (for example, a protein or small molecule). The interacting molecule may itself interact with further molecules
a sample of heparan sulfate derivative(s) bound to a synthetic molecule (e.g. peptide, chemical compound) or
a sample of two or more different HS derivatives or HS oligosaccharides

Preferably, the heparan sulfate derivative at each position is substantially pure but in certain circumstances mixtures of several or many different heparan sulfate derivatives can be present at each position in the pattern of an array. Thus initial bulk screening of sets of HS derivatives or HS oligosaccharides can be carried out on the array to determine those sets containing compounds of interest.

An array as defined herein is a spatially defined arrangement of heparan sulfate derivatives in solution, or in a pattern on a surface. In the latter case, the heparan sulfate derivatives are preferably attached either directly or indirectly via covalent or non-covalent bonds.

In a further embodiment, the invention provides a method of screening a library containing at least two heparan sulfate derivatives produced by the methods of the first and second aspect of the invention comprising the steps of:

(a) bringing all or a portion of said library into contact or proximity with a molecule, complex of molecules, cell or organism of interest,

(b) detecting an interaction between one or more compounds within said library and the molecule, complex of molecules, cell or organism of interest,

The screening of the libraries of the invention can give rise to useful compounds. Thus in a further embodiment, the invention provides use of one or more HS derivatives made by the methods of the invention or components of the same e.g. oligosaccharides, as enzyme substrates e.g. of sulphotransferases, as enzyme inhibitors e.g. of heparitinases, as epitopes to antibodies or phage display antibodies or libraries of these, as inhibitors of protein activity or ligands to proteins, or as components of multi- or polyvalent inhibitors of adhesin attachment in microorganisms (viruses, bacteria, tropanosomes to mammalian cells).

Naturally occurring heparan sulfate is scarce. However it may be synthesised by the methods of the invention which can produce a sample which is indistinguishable by some structural, functional or physico-chemical property from naturally occurring heparan sulfate.

Thus, in a further aspect, therefore the invention provides a method of providing heparan sulfate, where heparan sulfate means a polysaccharide that is indistinguisable by some test of activity or structure or other physico-chemical property from naturally occurring heparan sulfate.

The invention will now be further described by the following non-limiting examples which refer to the accompanying figures in which:

FIG. 1 shows a schematic of an example of the Analytical Tuning Process, illustrated by production of an oligosaccharide, (about which some structural detail is ascertained during the process) from a library of polysaccharides.

FIG. 2 shows a schematic of an example of the Empirical Tuning Process, illustrated by production of an oligosaccharide from a library of polysaccharides. No knowledge of the structure of the isolated oligosaccharide product or initial polysaccharides is necessary—only the synthetic history of the initial components of the polysaccharide library.

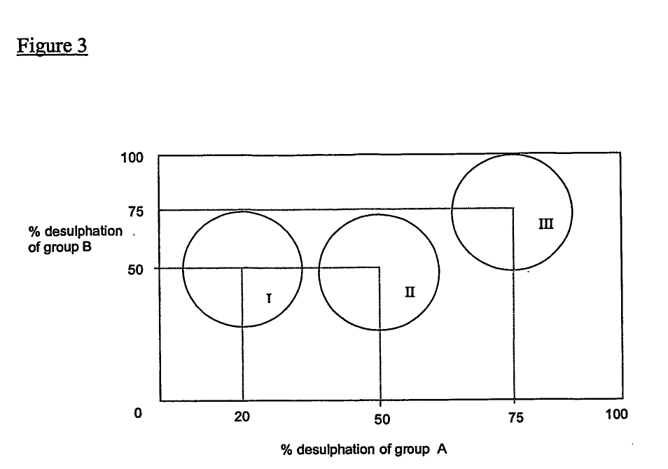

FIG. 3 is graphical illustration of how different chemically modified heparin preparations will contain a range of structures with varied levels of desulphation. The graph shows 3 different preparations each with a particular average level of desulphation for each of 2 different types of sulfate group (A and B). The average level is denoted by the centre of the circles. For example, preparation I is 20% desulfated at group A and 50% desulfated at group B; preparation II is 50%/50% desulfated and preparation III is 75%/75% desulfated. Note that although these are the average level of desulphation for these preparations, they will contain a range of structures with a variety of combinations of lower or higher levels of desulphation at each position. This results from two factors: the complex mixture of different sized molecules, possessing different sequences and the statistical distribution of chemical modifications within the sample. These are represented by the range of variations encompassed by the circles centred on the average desulphation level points. In each case a particular area of “structure space” is occupied. This is a simplified version with just 2 modifications shown. In more complicated preparations additional modifications could take this representation of structure space to 3 dimensions or more.

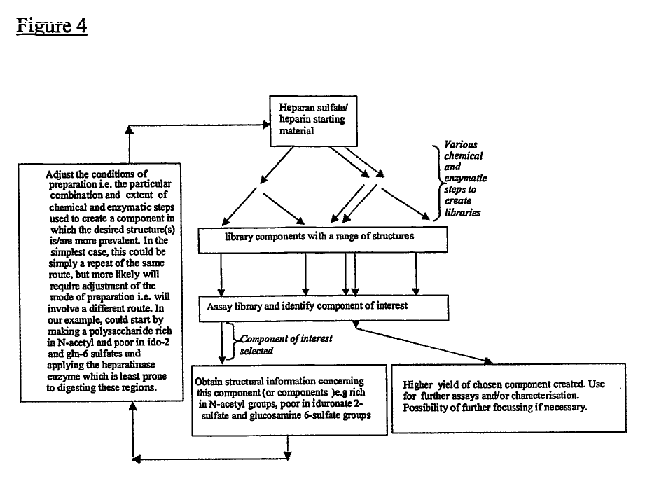

FIG. 4 is an illustration of how the tuning process works. Initial steps are denoted by black arrows, the feedback process following initial selection of an active component, by dotted arrows

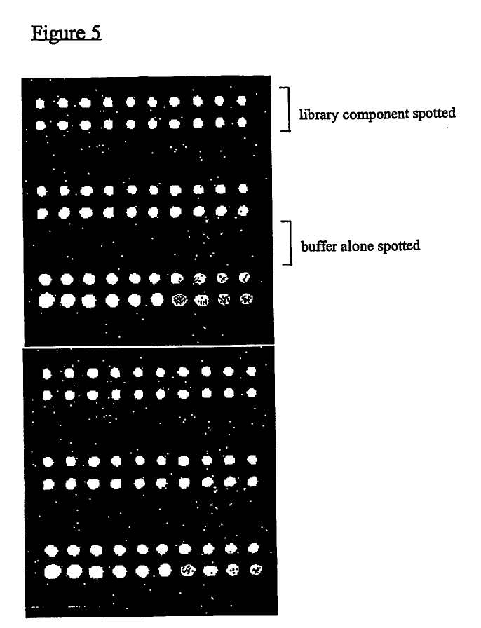

FIG. 5 is an illustration of the binding of a target (detected by a series of antibodies, one being fluorescently labelled) to a component of a library immobilised repetitively onto amino-derivatised glass slides at spatially discrete locations. Solvent without the library component present was spotted in between the rows of library components as a control. The upper and lower panels show regions of identical slides where immobilisation was via conventional heating or microwaving, respectively.

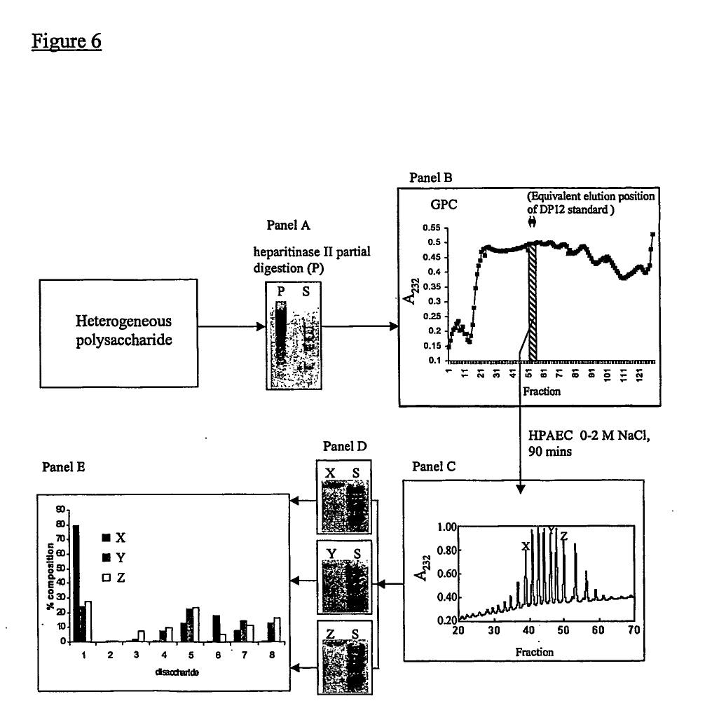

FIG. 6 The generation of oligosaccharide library components from a heterogeneous polysaccharide starting material. Clockwise: Panel A; electrophoresis of a heparitinase II digestion of the heterogeneous polysaccharide (P) compared to that of bovine lung heparin standard (S), which is comparatively homogeneous giving a characteristic ladder: Panel B; gel chromatography separation of digest (P) on Sephadex G-50 also showing equivalent elution position of a standard DP 12 oligosaccharide pool from (S): Panel C; HPAEC separation (0-2 M NaCl, pH 7, 90 mins) of the fraction of (P) which elutes at the same position as a bovine lung heparin DP 12 standard: Panel D; electrophoresis profiles of 3 example peaks from the HPAEC trace, X, Y and Z, compared to the standard ladder derived from bovine lung heparin (S): Panel E; Disaccharide compositional analysis of peaks X, Y and Z. Disaccharides: 1; UA-GlcNAc, 2; UA-GlcNAc(6S), 3; UA-GlcNS, 4; UA-GlcNS(6S), 5; UA(2S)-GlcNS, 6; UA(2S)-GlcNS(6S), 7; UA(2S)-GlcNAc, 8; UA(2S)-GlcNAc(6S)

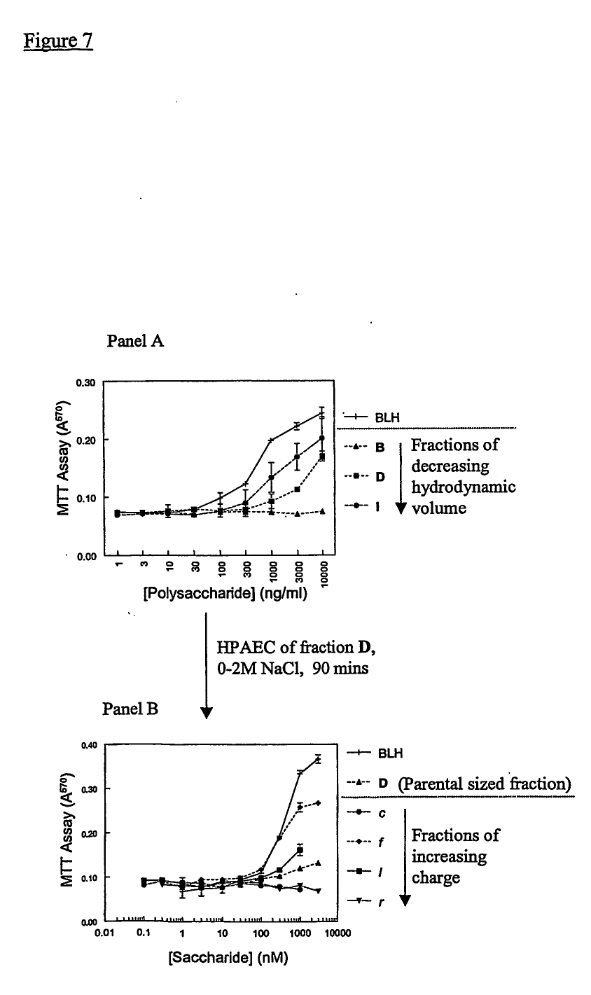

FIG. 7 The process of selecting active oligosaccharides, approaching minimum structural complexity, and capable of forming an active signalling complex between FGF1 and receptor 2c. Heterogeneous polysaccharide starting material was partially digested and the products fractionated into oligosaccharide fractions A-O (in order of decreasing hydrodynamic volume) by GPC. Panel A; activity assay of FGF1/R2c in BaF cells with representative, sized oligosaccharide pools B, D and I of increasing hydrodynamic volume from the GPC separation of the heterogenous polysaccharide digestion. The activity of bovine lung heparin (polysaccharide) is also shown as a positive control. Panel B; from these fractions, the smallest active fraction (D) was further separated by HPAEC into fractions a-t (in order of increasing anionic charge) and tested. The activity of representative samples c, f, l and r are shown for signalling of FGF1/R2c. The activities of the parent oligosaccharide pool (D) and bovine lung heparin (BLH) are also shown.

### EXAMPLES

### Example 1

### Targetted Chemical Modification of Heparin; Making a Library with Varying Degrees of N-Sulfation and N-Acetylation

There are several possible routes to obtain partially N-sulfated, N-acetylated heparan sulfate derivatives;

(1) partial de N-sulfation (by solvolytic desulfation under mild conditions, acidic treatment with aqueous mineral or organic acids), then re N-acetylation (e.g. by acetic anhydride in basic aqueous conditions) to substitute all unsubstituted amino groups. I.e. step one is controlled, step two not.

(2) complete de N-sulfation (by the reactions listed above but under harsher conditions of temperature or strength of acid used), then partial re N-acetylation (e.g. limiting the amount of acetic anhydride, reaction time or temperature), then re N-sulfate (by reaction of a sulfate donor, trimethylamine sulfurtrioxide in basic aqueous conditions) all remaining unsubstituted amino groups. I.e. step 2 is controlled, steps 1 and 3 not.

(3) complete de N-sulfation followed by simultaneous re N-sulfation and acetylation in the same vessel. This is possible because both reactions are carried out in saturated aqueous sodium bicarbonate solution.

(4) by a process involving de N-acetylation (hydrazinolysis or treatment with base), then re N-acetylation and/or N-sulfation as described in 1 to 3 above.

A summary of the essential components of the reactions mentioned above is given below;

1. De N-Sulfation

Several methods. Mild acidic cleavage using dilute acids plus time or heat to control extent. One method is to use solvolytic de-sulfation, which includes the use of the pyridinium (or other similar salt of an organic base) salt of heparin (or derivative) disolved, or suspended, in a mixture of DMSO and either water, methanol or other alcohol. The extent of de-sulfation is controlled with a combination of temperature and time. Other possibilities include heating in aqueous mineral or organic acids. If conditions are mild, selective de N-sulfation can be achieved, either partially or to completion.

2. Re N-Acetylation

This can be achieved using acetic anhydride on a solution of the heparin or derivative in solutions of sodium bicarbonate or similar water soluble base. It is usually carried out at low temperature followed by further reaction at room temperature; The extent of N-acetylation is controlled with the amount of reagent, temperature—or by the duration of the reaction.

3. Re N-Sulfation

This is achieved by using the trimethylamine.sulfurtrioxide complex (or a similar amine-sulfurtrioxide complex) on an aqueous solution of heparin (or derivative) and sodium bicarbonate, or a similar water soluble base. Characterisation of the products formed in these reactions can be done by 1H and 13C NMR, degradation with enzymes or nitrous acid, followed by any separation technique or by elemental analysis (to find total sulfation), or titration (to find N and O sulfation ratios).

### Example 2

### Synthesis of a Library Component Containing Partial O,N Sulfation and N-Acetylation from Heparin, Using the Chemical Steps Described Above

1. Preparation of Heparan Sulfate Derivative with Partial Ido-2 De-Sulfation and Glucosamine-6 De-Sulfation

Heparin was converted to its pyridinium salt by passage through an acidic ion exchange column followed by neutralisation with pyridine and evaporation of excess water and pyridine to give the salt. This was then suspended in DMSO/MeOH (9/1, v/v) and heated (e.g. 18 h, 65 degrees C.). The reaction was cooled, and the pH adjusted to 8 with dilute NaOH. Products were precipitated into a large volume of cold ethanol and the products precipitated. The products were recovered by filtration, salts largely removed by dialysis and the products purified by desalting and the product, heparin derivative A, characterised. This results in a product with completely de N-sulfated glucosamine residues and partially de-O-sulfated residues at position 2 of iduronate and 6 of glucosamine.

2. Preparation of Heparan Sulfate Derivative with Partial N-Acetylation

Heparin derivative A (100 mg) was dissolved in an aqueous, saturated solution of NaHCO₃ (5 ml) at 4 degrees C. and acetic anhydride (2.5 molar equivalents) was added dropwise. The reaction was maintained at 4 degrees C. for another 4 hours and then allowed to reach room temperature and stirred overnight. After completion of this reaction, the solution was poured into a large volume of cold ethanol and the products and salts precipitated. The products were recovered by filtration, salts largely removed by dialysis and the products purified by desalting and the product characterised.

3. Re N-Sulfation of Remaining Unreacted Amino Groups.

The product of steps (1) and (2) was dissolved in a saturated aqueous solution of sodium bicarbonate (10 ml) and a 10-fold molar excess of trimethylamine sulfur trioxide complex was added, with stirring at 50 degrees C. overnight. The reaction mixture was then cooled and the polysaccharide products were precipitated into cold ethanol, filtered, dialysed, recovered and purified. The products were then characterised.

### Example 3

### Screening Components of the Library as an Array for Binding to Target Proteins and Cells

Spatially separated components of a library were spotted in formamide onto glass slides possessing functional amino groups using a robotic spotter. The immobilisation reaction was allowed to proceed at 37 to 80° C. for at least 5 days. Alternatively, the slides were heated in a conventional microwave oven (850 W) at half power for five minutes before standing at ambient temperature in the dark for ten minutes and repeating this procedure again twice. The arrays were then washed in a suitable solvent and incubated sequentially with bovine serum albumin (BSA), target (e.g. peptide, protein or cells) and then primary antibody raised against the proteins or cells and secondary antibody (if either required) all diluted to appropriate concentrations in a suitable buffer. The target, primary or secondary antibody are labelled with a suitable fluorophore for detection. At each step following immobilisation the slide was washed with a suitable solvent. After the final step the slide was washed with solvent, dried and scanned using a fluorescent slide scanner producing a image such as FIG. 5

### Example 4

### Assaying the Components of a Library for the Ability to Stimulate BaF3 Cell Proliferation

BaF3 cells are a pre-lymphoid cell line, lacking HS chains and expressing a type of fibroblast growth factor receptor. BaF3 cells were transferred at a suitable cell density from medium supplemented with interleukin 3 growth factor (IL3), required as a survival factor, into medium lacking IL3 and supplemented with a suitable concentration of a fibroblast growth factor (FGF) and the component of the library under test. As controls cells are also transferred to medium lacking both FGF and the library division as well as to medium possessing one of the supplements alone. The cells were incubated at 37° C. with 5% carbon dioxide for a suitable period of time before determining the number of viable cells and comparing the library division results with the controls.

### Example 5

### Production of a Diverse Library; Its Use to Identify Active Structures, to Tune the Library for the Production of More Active Fragments

(i). A sample of the starting material e.g heparin is taken

(ii). A number of modifications according to the first aspect of the invention to cover the desired degree of structural diversity are carried out

e.g. a graded series of N-acetylations in combination with a graded series of de-O-sulfations (the preferred route). This is done as follows:

Some heparin is taken
Partial O-de sulfation and simultaneous complete de-N-sulfation is carried out;
The pyridinium salt of HS is formed and freeze-dried. It is dissolved and heated in a solution of DMSO/MeOH (9/1, v/v) for various times at various temperatures e.g. 75 degrees C. for 6, 12, 24 (could be chosen at random or pre-determined by experiment). Aliquots are removed (or alternatively, discrete reactions can be carried out for the desired time points in discrete locations) at desired time points, cooled, the pH adjusted to ca. 8 (NaOH(aq)), precipitated into ethanol (cold), filtered and washed (EtOH), then dialysed against distilled water.
   (iii). Partially re N-acetylate the HS.

The product (e.g. 25 mg) is dissolved in sat. aq. NaHCO₃ (1 ml), acetic anhydride added (in a number of known, varying quantities corresponding to known molar equivalents, depending on the extent required) at 4 degrees C. and stirred for 1 hour. The cooling is removed and the reaction allowed to stir at room temperature overnight. The products are precipitated into cold EtOH, filtered, washed (EtOH) and dialysed against distilled water.

(iv). Replace N-sulfates.

The products are dissolved in saturated aqueous NaHCO₃ and trimethylamine.sulfurtrioxide complex added (in 10-fold molar excess, or greater, if complete re N-sulfation is required) at 50 degrees C., stirred for 24 hours, cooled and precipitated into EtOH (cold), filtered, washed (EtOH) and dialysed against distilled water.

(v). Degrade to oligosaccharides by heparitinase enzymes (could also use nitrous acid degradation or free radical degradation as well).

The polysaccharide (<1 mg/ml) is dissolved in the appropriate enzyme buffer (Ca(OAc)₂, NaOAc) and digestion carried out with the appropriate enzyme (e.g. heparitinase III, 1 ul per ml of polysaccharide solution, 2.5 mU/10 ul), incubated at 37 degrees C. for the desired time or times. The enzyme digestion is stopped by briefly heating the samples at 100 degrees C. (2-5 minutes).

(vi). Separate the oligosaccharides so formed into discreet physical locations e.g. by strong anion exchange hplc, or electrophoresis.

The products are assayed singly, or in groups for a particular activity (or property) of interest. If required, something is ascertained about their structure, for example, by disaccharide compositional analysis.

NB. At the end of each step (especially (ii), (iii) and (iv)) structural elucidation (e.g. by NMR) may be required to check that the desired level and type of modification has been successfully carried out. After step (v), it may be required to check the degree of degradation e.g. by electrophoresis or hplc.

(vii). Tuning method e.g. “analytical”.

It may be that, for instance, at step (vi), a particular structure from the diverse library is found to be active and this turns out to be rich, for example, in N-acetylated glucosamine, glucosamine 6-sulfate and iduronate 2-sulfate, as found by some structural elucidation method (e.g. disaccharide compositional analysis). It would therefore be required to make a polysaccharide rich in these structures, which could be done as follows:
I(i) *de-N-sulfation
The pyridinium salt is formed and freeze-dried. This is dissolved in a solution of DMSO/MeOH (9/1, v/v) and heated for 2 hours at 55 degrees C. Aliquots are removed at desired time points, cool, the pH adjusted to ca. 8 (NaOH(aq)), precipitated into ethanol (cold), filtered and washed (EtOH), then dialysed.
I(ii) *re N-acetylation
The product is dissolved in saturated aqueous NaHCO₃, add acetic anhydride added (in 10-fold molar excess) at 4 degrees C. and stirred for 1 hour. The cooling is removed and stirred at room temperature overnight. The products are precipitated into cold EtOH, filtered, washed (EtOH) and dialysed.
I(iii) ascertain overall degree of modification.
Following modification, the structural integrity of the polysaccharide is checked (e.g. by NMR, in which the peaks apparent in the spectra are correlated with the structures present (averaged over the whole sample): This information can be used to evaluate the degree of sulfation and acetylation at the various positions within the sample).
*The products are then degraded by enzymes to the desired extent (this can be tested first if required, but is a parameter that can itself be tuned, for example, to generate more longer fragments or more shorter fragments, as required).
I(iv) Degrade to oligosaccharides by heparitinase enzymes (could also use nitrous acid degradation or free radical degradation as adjuncts and/or alternatives).
The polysaccharide is dissolved (<1 mg/ml) in the appropriate enzyme buffer (Ca(OAc)₂, NaOAc) and digestion carried out with the appropriate enzyme added (e.g. heparitinase III of activity 2.5 mU per 10 ul, 1 ul per ml of polysaccharide solution), incubating at 37 degrees C. for the desired time or times. The enzyme digestion is stopped by briefly heating the samples at 100 degrees C. (5-10 minutes).
I(v) separate
The products are separated into discreet locations (for example, by hplc).
The activity is checked and the structure of the most interesting component(s) determined. If further adjustment of the parameters is required, this is done to create further libraries until satisfied that the activity (or whatever property is of interest) has been optimised. This is an example of the analytical tuning process described in FIG. 1.
N.B. An alternative tuning process is also available, which we term the empirical tuning process and is described in FIG. 2. It starts with selection of a product with a desired activity, whose synthetic history is known, but whose structure may or may not be. This process differs from the empirical tuning method at points marked * in this example, where conditions can be varied to give a range of similar, but distinct products and no structural check need necessarily be made on the products. Products are identified only by their separation characteristics and/or activity. The former can be considered as providing no information, i.e. it could be effectively ignored or, alternatively, it could be considered to provide sketchy or fuzzy information about structure e.g. more sulfated saccharides tend to elute later from hplc columns than less sulfated ones, but this does not provide a detailed description of its structure
In both tuning processes, it is also possible to optimise the ratio of two parameters, either structural and/or functional.

The result of these processes will be components with optimised parameters of interest.

### Example 6

### Production of Diverse Library Components Containing Active Fragments and Illustration that Tuning can Involve Degradation Techniques as Well as, or Instead of, Chemical Modifications

1. A sample of heparin is taken

2. Modifications to remove O-sulfates at positions glucosamine-6 and iduronate-2 to a range of extents is carried out, this also removes all N-sulfates at the same time.

The pyridinium salt is formed and freeze-dried. This is dissolved in a solution of DMSO/MeOH (9/1, v/v) and heated for a variety of time points at one temperature (or various temperatues as required). Aliquots are removed at desired time points, (or alternatively, reactions are carried out in discrete vessels for the required range of conditions) cooled, the pH adjusted to ca. 8 (NaOH(aq)), precipitated into ethanol (cold), filtered and washed (EtOH), then dialysed. The extent of modification is ascertained e.g. by NMR. This forms a number of products with varying degrees of O-sulfation at position-2 of iduronate and position-6 of glucosamine.

3. replace some N-acetyl groups and the remaining free amines with N-sulfate to give products with variable N-acetyl/N-sulfate ratios.

The product is dissolved in saturated aqueous NaHCO₃, acetic anhydride added (in a number of known, varying quantities) at 4 degrees C. and stirred for 1 hour. The cooling is removed and allowed to stir at room temperature overnight. The products are precipitated into cold EtOH, filtered, washed (EtOH) and dialysed. The extent of modification is ascertained e.g. by NMR. This forms a number of products with varying levels of N-acetylation.

The remaining free amino groups are re N-sulfated by dissolving the product in saturated NaHCO₃, excess trimethylamine.sulfurtrioxide added and the reaction heated at 55 degrees C. overnight. The reaction is cooled, precipitated into ethanol, filtered and dialysed against distilled water. The extent of modification in each component of the library e.g. by NMR is ascertained. This yields a library of modified polysaccharides containing variable O-sulfation at position 2- of iduronate, position-6 of glucosamine and at the amine group of glucosamine.

4. having produced this polysaccharide library, generate mixtures of oligosaccharide fragments by partial enzymatic and/or chemical digestion

The sample is dissolved in lyase buffer (Ca(OAc)₂NaOAc) at <1 mg/ml and add (e.g. 1 ul of heparitinase III enzyme per ml of polysaccharide) added and incubated at 37 degrees C. for various times. The progress of digestion can be monitored by removing aliquots at various time points, heating the samples briefly at 100 degrees C. and monitoring the extent of degradation e.g. by running the samples on an electrophoresis gel and detecting the oligosaccharides (against standards) by staining with e.g. Alcian blue/Azure A.

5. separate these pools of mixed oligosaccharides e.g. by hplc and assay fractions for a particular activity of interest

A sample of the digestion (e.g. 0.5 mg in 1 ml water) is added to astriong anion exchange column and eluted with a linear gradient of NaCl (0-2M, pH 7, over 120 minutes at 1 ml per minute) monitoring the elution position of products by their absorbance at 232 nm. The eluant is fractionated into 1 ml tubes (e.g. at 1 ml/min). Samples can be assayed for a particular activity of interest.

6. isolate oligosaccharide of interest and determine structural details

This process may yield, for example, a saccharide, which upon structural elucidation e.g. by gel or mass spectrometry based sequencing techniques, is revealed to be, for instance, a tetrasaccharide containing glucosamine N-sulfate groups, low levels of O-sulfated iduronate and sulfation at position-6 of glucosamine).

7. prepare a polysaccharide with very low levels of iduronate-2 sulfate and glucosamine-6 sulfate by,

I(i) A sample of HS is taken
I(ii) It is subjected to de-O-sulfation for a prolonged period (also achieving de N-sulfation at the same time)
The pyridinium salt is formed and freeze-dried. This is suspended in a solution of DMSO/MeOH (9/1, v/v) and heated for 24 hours at 100 degrees The sample is removed cooled, the pH adjusted to to ca. 8 (NaOH(aq)), and the products precipitated into ethanol (cold), filtered and washed (EtOH), then dialyses. The degree of modification is ascertained e.g. by NMR.
I(iii) re-N-sulfate the remaining free-amino groups to completion
The product is dissolved in saturated aqueous NaHCO₃, excess trimethylamine.sulfurtrioxide added at 55 degrees C. and stirred overnight. The reaction is cooled and the products are precipitated into cold EtOH, filtered, washed (EtOH) and dialysed. The degree of modification is ascertained e.g. by NMR.
I(iv) In a trial run, digest it extensively with the same enzyme
The sample is dissolved in lyase buffer (Ca(OAc)₂/NaOAc) at <1 mg/ml and enzyme (e.g. 1 ul of heparitinase III enzyme per ml of polysaccharide) added. The digest is incubated at 37 degrees C. for a variety of time points. The progress of digestion is monitored by removing aliquots at various time points, heating the samples briefly at 100 degrees C. checking (e.g. by comparing the migration of the digested fractions against standards by gel electrophoresis and staining with alcian blue/azure A) for the degree of degradation achieved, until a high yield of (in this case) tetrasaccharides has been obtained. Digest more of the sample in the same way to obtain a large quantity of pooled tetrasaccharides.
I(v) These pooled oligosaccharides are separated (e.g. by hplc) and the fraction that contains the oligosaccharide of interest is identified. This could be done on the basis of some structural test (e.g. by mass spectrometry, sequence analysis, elution position on hplc) and/or some functional property. This illustrates that not only the chemical modification steps but also the enzymatic step is a tunable aspect of the process.

### Example 8

### An Illustration of the Generation of Structurally Diverse Oligosaccharide Libraries

(a). Generation of Diverse HS Analogue Libraries.

The generation of diverse HS analogue libraries from a heterogeneous polysaccharide is illustrated in FIG. 6. The electrophoresis profile of a partial digestion with heparitinase II of a structurally diverse polysaccharide is shown (panel A). The products are first fractionated on the basis of their hydrodynamic volume on Sephadex G-50 (panel B). This profile is similar to that obtained from a typical enzymatic digestion of heparin or heparan sulfate. However, when peaks corresponding to particular hydrodynamic volume ranges, in this case DP12 of bovine lung heparin derived standards, are further fractionated on the basis of overall charge by HPAEC (panel C), a distinct pattern is observed. Instead of a range of separable peaks, typical of a modest number of saccharides, the overall chromatogram is bound by an approximately Gaussian envelope, inside of which are discrete, regularly spaced peaks. This is a typical example of the appearance of HPAE chromatograms of gel chromatography fractions from enzyme digestions of this kind of highly heterogeneous polysaccharide. The heterogeneity of each of these peaks is further demonstrated by their profile on an electrophoresis gel (examples labelled A, B and C in FIG. 5 (panel D)) which separates them on the basis of a combination of charge, size and conformation. Comparing the appearance of these diffuse bands (which, because of their lower overall sulfation levels, run higher up the gel), with their more highly charged and homogeneous counterparts derived from bovine lung heparin (shown as standards, S in panel D), it is clear that the standards run as tighter bands and this is especially evident for those larger than DP 6. Each of the discrete peaks on the HPAEC trace contains a diverse range of structures forming sub-libraries of oligosaccharides. These data together with the composition analysis of peaks A, B and C from HPAEC (panel E) suggests that they contain complex mixtures of oligosaccharides.

(b). The Use of the Library to Select Active Structures Approaching Minimum Complexity

An illustration of the use of the library to select active oligosaccharide sets (or sub-libraries) with minimum size and charge is shown in FIG. 6 for the fibroblast growth factor-receptor (FGF/FGFR) system in an in vitro cell assay with Baf3 cells, in which the ability of fractions to support signalling with FGF-1/R2c is measured. Testing the activities of fractions from the partial heparitinase digestion separated by gel chromatography (panel A) allows a pool of oligosaccharides to be selected on the basis of activity while minimising size and charge. It is noteworthy that higher hydrodynamic volume does not necessarily bestow higher activity, as illustrated in FIG. 6 (panel A) for three fractions denoted B, D and I. Further separation, on the basis of charge of the smallest significantly active fraction, in this case D, by HPAEC and subsequent testing of the resultant fractions for activity, allows the search to be focussed. Higher charge does not necessarily correlate with higher activity as illustrated by the activities of HPAE fractions c, f, l and r (panel B). Fractions exhibiting both higher activity (e.g. f) and lower activity (e.g. r) than the parent (D) can be identified, indicating that a degree of specificity is present in FGF/FGFR/HS interactions. It should also be noted that (polymeric) heparin, which is used here as a positive control, is likely to appear a disproportionately effective activator compared to oligosaccharides because it possesses many more active sites. Additional iterations of the separation and screening process will allow increasingly focussed structure/activity relationships to be sought.

(c) Methods

1. Chemical Preparation of Heterogeneous Polysaccharide

(a) Partially De O-, Completely De N-Sulfated Heparin

Porcine intestinal mucosal heparin (Celsus Labs, Cincinatti, Ohio, USA, 5 g) was converted to the pyridinium salt by passage through Dowex W-50 cation exchange resin (H⁺ form), neutralised with pyridine and freeze-dried (4.9 g). This was then suspended in a solution of DMSO/MeOH, 9/1, v/v (100 ml) and heated at 80° C. for a time (24 h), determined empirically following removal of aliquots (10 ml), recovery and analysis by NMR. The product was recovered and purified by gel chromatography and analysed by NMR to verify its structural heterogeneity in terms of partial de O-sulfation and complete de N-sulfation. It was then subjected to partial re N-acetylation.

(b) Partial Re N-Acetylation

Partial re N-acetylation was achieved with acetic anhydride in a saturated solution of sodium bicarbonate upon the partially de O-sulfated polysaccharide but its extent, determined empirically by monitoring aliquots by NMR following recovery, was limited by controlling the quantity of acetic anhydride used. Products were isolated and characterised by NMR and, following exhaustive degradation with heparitinase enzymes, disaccharide analysis.

(c) Re N-Sulfation of Remaining Unsubstituted Amino Groups

The remaining free-amino groups were re N-sulfated (twice) using trimethylamine sulfurtrioxide as the sulphating agent. Following this procedure, the compound was purified by gel chromatography and its high levels of heterogeneity confirmed by compositional analysis: UA-GlcNAc; 24.5%, UA-GlcNAc(6S); 13.7%, UA-GlcNS; 7.0%, UA-GlcNS(6S); 13.0%, UA(2S)-GlcNS; 13.7%, UA(2S)-GlcN(6S); 13.6%, UA(2S)-GlcNSAc; 11.4%, UA(2S)-GlcNAc(6S); 3.1%.

2. Characterisation of Polysaccharide

(i) NMR: The effectiveness of the chemical treatments were monitored by ¹H and ¹³C NMR spectroscopy at 500 and 125 MHz in D₂O on a Bruker spectrometer operating at 27° C. Chemical shifts (relative to an external standard) were assigned and the compound characterised by NMR.

(ii) Disaccharide analysis following exhaustive digestion with heparitinases I, II and III: Samples (typically 100 ug) were exhaustively digested with a combination of heparitinase enzymes I, II and II (Seikagaku) in lyase buffer at 37° C. (500 mM NaOAc, 2.5 mM Ca(OAc)₂, pH 7). Subsequent comparison with disaccharide standards following separation by HPAEC on a Propac PA-1 column (4×250 mm, 0-2 M NaCl gradient over 90 mins, detecting at 232 nm) allowed each component to be quantified.

3. Partial Degradation of Heterogeneous Polysaccharide with Heparitinase II

The polysaccharide (50 mg) was partially digested with hepaitinase II (Seikagaku) in lyase buffer (as above) at 37° C. The progress of the digestion was monitored by electrophoresis of the products by staining with Alcian blue/Azure A and was stopped when a range of digested products was detected with reference to a pair-wise ladder of heparin fragments.

4. Fractionation of Products by Gel Permeation Chromatography

The partially digested products were separated on the basis of their hydrodynamic volume on a column of Sephadex G-50 (2.5 cm×1.75 m) eluting with 100 mM NH₄HCO₃, detecting at 232 nm. The column was calibrated (before and after separation) with a pair-wise ladder of heparin oligosaccharides derived by partial heparitinase digestion. Fractions (denoted A-O) were desalted, quantified (A₂₃₂) and tested for efficacy in a number of assays following quantification.

5. Fractionation of Hydrodynamic Volume Defined Products by HPAEC

Selected fractions from the gel permeation chromatography separation were desalted and fractionated on HPAEC on a Propac PA-1 column (4×250 mm, 0-2 M NaCl gradient over 90 mins, detecting at 232 nm). Peaks were collected (selected peaks were denoted A, B and C for use in the experiments shown in FIG. 5, but the full range were denoted a-p for use in those shown in FIG. 6) de-salted and quantified (A₂₃₂) for subsequent analysis and testing.

6. BaF3 Cell Assay with FGFs and FGFRs.

BaF3 cells transfected with the appropriate receptor were maintained in RPMI-1640 supplemented with 10% foetal calf serum, 2 mM L-glutamine, 1000 U·ml⁻¹ pen G, 50 μg·ml⁻¹ streptomycin sulfate and 2 ng·ml⁻¹ IL-3. Assays for saccharide function were as follows. Briefly, BaF3 cells were transferred to 96 well plates at 10000 cells per well in 100 μl medium without IL-3, supplemented with 1 nM of the appropriate FGF saccharide samples. Pools of saccharides from gel chromatography (denoted A to O) were used between 1.0 ng·ml⁻¹ and 10,000 ng·ml⁻¹ and from HPAEC (denoted a to t) were used between 0.1 and 3,000 nM. Cells were incubated (37° C., 72 hours). 5 μl MTT (5 mg·ml⁻¹ in PBS) was added and cells incubated (a further 4 hours, 37° C.). Cells were solubilized (10% SDS, 0.1 N HCl). Absorbance of solubilized samples was measured at 570 nm.

1. A method for the production of a library of heparan sulfate derivatives said method comprising a combination of chemical modification steps in which at least one, two or three modification steps of said combination are selected from the group A to O wherein:
A. partial de N-sulfation in glucosamine
B. complete de N-sulfation in glucosamine
C. partial de N-acetylation in glucosamine
D. complete de N-acetylation in glucosamine
E. re N-sulfation in glucosamine of all available amino groups
F. re N-acetylation in glucosamine of all available amino groups
G. partial re N-sulfation in glucosamine
H. partial re N-acetylation in glucosamine
I. complete de-O-sulfation at position 6 of glucosamine
J. partial de-O-sulfation at position 6 of glucosamine
K. partial de-O-sulfation at both position 6 of glucosamine and 2 of iduronate accompanied by complete de N-sulfation in glucosamine.
L. complete de-O-sulfation at both position 6 of glucosamine, 2 of iduronate and de-N-sulfation in glucosamine
M. partial de-O-sulfation at position 6 and complete de-N-sulfation of glucosamine
N. complete de-O-sulfation at position 2 of iduronate
O. complete de-O-sulfation at position 6 and de N-sulfation of glucosamine and partial de-O-sulfation of iduronate.

2. The method of claim 1 wherein all steps of said combination are chosen from the group A to O.

3. The method according to claim 1 wherein said library is structurally more diverse than the heparan sulfate starting material from which it is derived.

4. The method according to claim 1 wherein at least one modification step in said combination is a partial modification.

5. The method according to claim 1 wherein at least one complete or partial modification is carried out at the amino function (N—) of glucosamine.

6. The method according to claim 1 wherein at least two modification steps in said combination are partial modifications.

7. The method according to claim 1 wherein at least three modification steps in said combination are partial modifications.

8. The method according to claim 1 wherein a first step of modification is chosen from A, B, C or D, such that wherein step A is chosen, optional subsequent steps are one or more of E, F, G, H, I, J, K, L, M, N, O, in any combination, or wherein step B is chosen, optional simultaneous or subsequent steps are one or more of E, F, G, H, I, J, K, L, M, N, O, in any combination.

9. The method according to claim 8 wherein a second step of modification chosen from E, F, G, or H is performed upon the modified products of said first step.

10. The method according to claim 9 wherein a third step of modification chosen from A, B, C, D, E, F, G, H, I, J, K, L, M, N, O is performed upon the modified products of said second step.

11. The method according to claim 10 wherein a fourth step of modification chosen from A, B, C, D, E, F, G, H, I, J, K, L, M, N, O is performed upon the modified products of said third step.

12. The method according to claim 11 wherein the combination of modifications is chosen from a first step and second to fourth optional steps such that:

| | Optional | Optional | Optional |
|---|---|---|---|
| First Step | Second Step | Third Step | Fourth Step |
| B(+/−any of I to O) | G | F/H | |
| B(+/−any of I to O) | H | E/G | |
| B(+/−any of I to O) | E | | |
| B(+/−any of I to O) | F | | |
| A | F | +/−any of I to O | E/G |
| A | H | +/−any of I to O | E/G |

13. The method according to claim 12 wherein said first step modification is B (+/− any of I to O), said second step modification is H, and said third step modification is E or G.

14. The method according to claim 12 wherein said first step modification is B (+/− any of I to O), said second step modification is G, and said third step modification is F or H.

15. The method according to claim 1, the method comprising the additional steps (singly or jointly) of
(a)(i) determining at least one functional property of one or more compounds;
(b)(i) making a further library via the method according to claim 1 wherein said modifications are chosen according to the functional determination or determinations made in step (a)(i); and/or;
(a)(ii) determining at least one structural feature of one or more compounds;
(b)(ii) making a further library via the method according to claim 1, wherein said modifications are chosen according to the structural determination or determinations made in step (a)(ii); and/or,
(b)(iii) making a further library via the method according to claim 1, wherein said modifications are chosen according to both said functional determination(s) made in step (a)(i) and said structural determination(s) made in step (a)(ii).

16. A method of producing a supplementary library of modified heparin derivatives comprising steps (singly or jointly)
(i) screening a library of heparan sulfate derivatives for compounds which have particular structural and/or functional characteristics,
(ii) determining at least one structural feature of the compounds having said particular structural and/or functional characteristics, or
(iii) determining at least one functional property of the compounds having said particular structural and/or functional characteristics, or
(iv) determining at least one functional and one structural property of the compounds having said particular structural and/or functional characteristics;
steps (ii), (iii) and (iv) being followed by step
(v) making said further library via the methods of claim 1 wherein the modifications and number of modification steps are chosen according to the determinations of steps (ii), (iii) or (iv).

17. The method according to claim 16 wherein the library of step (i) is made by a method according to claim 1.

18. The method according to claim 16 wherein at step (v) a single combination of modification steps is chosen in order to reproduce only the compound(s) having said desired characteristics.

19. The method according to claim 16 wherein the structural determination(s) made at step (ii) or (iv) is/are provided by the discreet known location, in a spatially separated library, of the compounds having said particular structural and/or functional characteristics.

20. A library containing at least two heparan sulfate derivatives produced by the method of claim 1.

21. The library according to claim 20 in which the compounds contained therein are spatially separated from each other.

22. The library, or components of the library produced by the method of claim 1, in which said components are:
(a) spatially separated,
(b) spatially separated into defined locations,
(c) spatially separated into defined locations and attached to a surface,
(d) spatially separated such that an interaction between one or more compounds within said library and the molecule, complex of molecules, cell or organism of interest can be detected,
(e) spatially separated into defined locations such that an interaction between one or more compounds within said library and the molecule, complex of molecules, cell or organism of interest can be detected,
(f) spatially separated into defined locations and attached to a surface such that an interaction between one or more compounds within said library and the molecule, complex of molecules, cell or organism of interest can be detected.
